(19) United States
(12) Patent Application Publication
(10) Pub. No.: US 2005/0049889 A1
(43) Pub. Date: Mar. 3, 2005

(54) Wallpaper catalogue system

(76) Inventor: Janice Lorraine Stiles, Liverpool, NY (US)

Correspondence Address: JANICE L. STILES, PRES/CEO;JLS COMPUTER SERVICES, INC, 8204 PENELOPE LANE, LIVERPOOL, NY, 13090, US

(21) Appl. No.: 10/652,937

(22) Filed: Sep. 2, 2003

(51) Int. Cl. G06F 17/60

(52) U.S. Cl. 705/1

(57) ABSTRACT

A computerized method will help retailers sell more special order wallpaper and millwright and manage wallpaper and millwright catalogue book inventory better. More specifically, the computerized method will help find patterns with specific motifs and/or colors, sign wallpaper books out of a retail store, sign wallpaper books back in as they are received/returned to the store, provide the ability to define wallpaper and millwright catalogue books, provide the ability list book inventory and status, provide the ability to print marketing information on customer printouts and provide the ability to backup and restore the system database.

### RELATED APPLICATIONS

None known.

### STATEMENT REGARDING FEDERAL SPONSORSHIP OF RESEARCH AND DEVELOPMENT

Research and development of the Wallpaper Catalogue System was not federally sponsored.

### COMPUTER PROGRAM LISTINGS

Listing of source code the Wallpaper Catalogue System is included on CD-ROM with this application and specification.

### BACKGROUND OF THE INVENTION

A retailer of special order wallpaper must maintain hundreds of wallpaper books in order to do business in an effective and competitive manner. One book can contain hundreds of patterns with various motifs and colors. It is often the case that customers want patterns that have specific motifs and/or color schemes. Therefore, in order to more efficiently sell this special order wallpaper and compete in that market, the retailer's sales personnel must be able to quickly find specific patterns from the thousands that exist in the books. Otherwise, a customer faces the sometimes overwhelming and/or time-consuming task of searching through the retailer's wallpaper books.

Once a book is located, the customer often wishes to “sign/check” the book out of the retailer's store for a short period of time. This action is desirable because the customer may wish to determine if a pattern will match his/her current decor. This action may require locating a sales person who may be busy working with other customers.

If the customer wishes to order patterns from home, the retailer does not necessarily have a copy of the ordering information in the store. Therefore, the book must be returned and an order placed at that time, which may inconvenience the customer.

Maintaining the retailer's wallpaper book inventory is also a time-consuming task. Books that have been checked out and are overdue for return must be followed up on. New books must be reviewed by all special order sales personnel for content. Periodically, wallpaper vendors discontinue wallpaper books and these must be located and discarded.

Special order wallpaper sales personnel sometimes miss opportunities to sell additional related products. Also, not all of these individuals are knowledgeable about removing or installing wallpaper.

Accordingly, what is needed is a way to help a special order wallpaper retailer help its customers find appropriate patterns, manage its book inventory better and sell more related products.

### SUMMARY OF THE INVENTION

The present invention may be implemented as a computerized method for:
Finding patterns with specific motifs and/or colors
Signing wallpaper books out of a retail store or allowing a customer to be added to a wait list if the book is not currently available
Signing wallpaper books back in as they are received/returned to the store
Providing for the ability to add books to the retailer's inventory either by sales personnel defining motifs and colors or by the wallpaper vendor providing that information
Providing for the ability to update information about the books
Providing for the ability to archive discontinued books
Providing for the ability to retain wallpaper ordering information on each book
Printing a list of the book inventory
Printing a list of books that are currently in “checked out” status
Providing for the ability to print reminders on search and sign out printouts about a potential need for additional products and to print other marketing information
Providing the ability to easily backup and restore the database so that higher-level database administration is not required
Providing for the ability to secure certain functions so that they can only be used by certain authorized personnel

### DESCRIPTION OF THE DRAWINGS

FIG. 1 gives an overview of the various screens in the system;

FIG. 2 illustrates one example of a main menu;

FIG. 3 illustrates one example of an interactive search window;

FIG. 4 illustrates one example of a search results window;

FIG. 5 illustrates one example of an interactive sign out window;

FIG. 6 illustrates one example of an interactive sign in window;

FIG. 7 illustrates one example of an interactive book add/update/archive window;

FIG. 8 illustrates one example of an interactive pricing information window;

FIG. 9 illustrates one example of a window that lists book inventories;

FIG. 10 illustrates one example of a window that formats customer marketing data; and

FIG. 11 illustrates one example of a window to backup and restore the database.

### DETAILED DESCRIPTION OF THE INVENTION

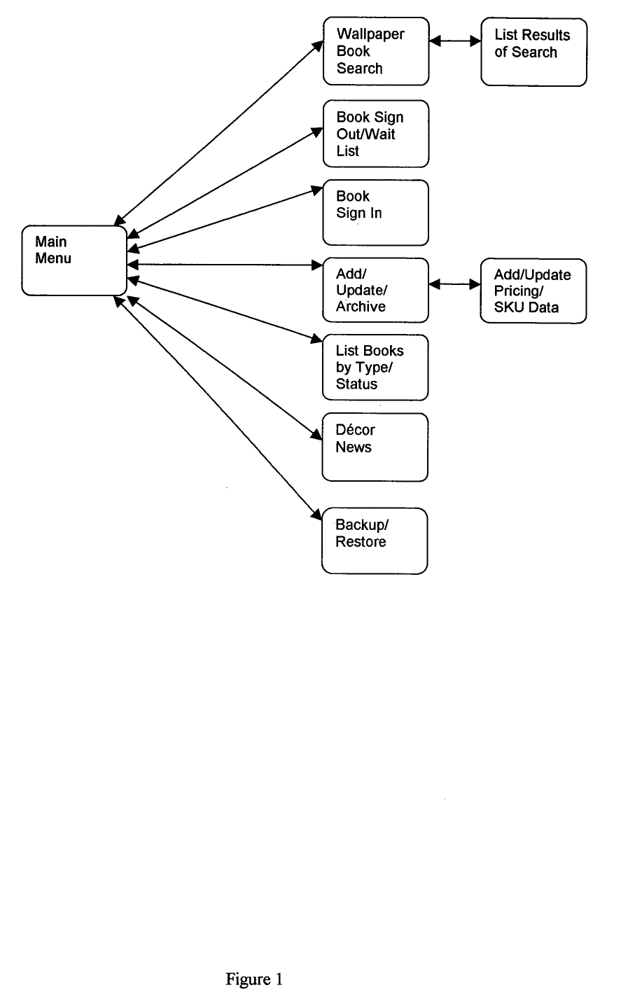

FIG. 1 is a diagram to illustrate generally how a user of the system could navigate among the system screens/windows.

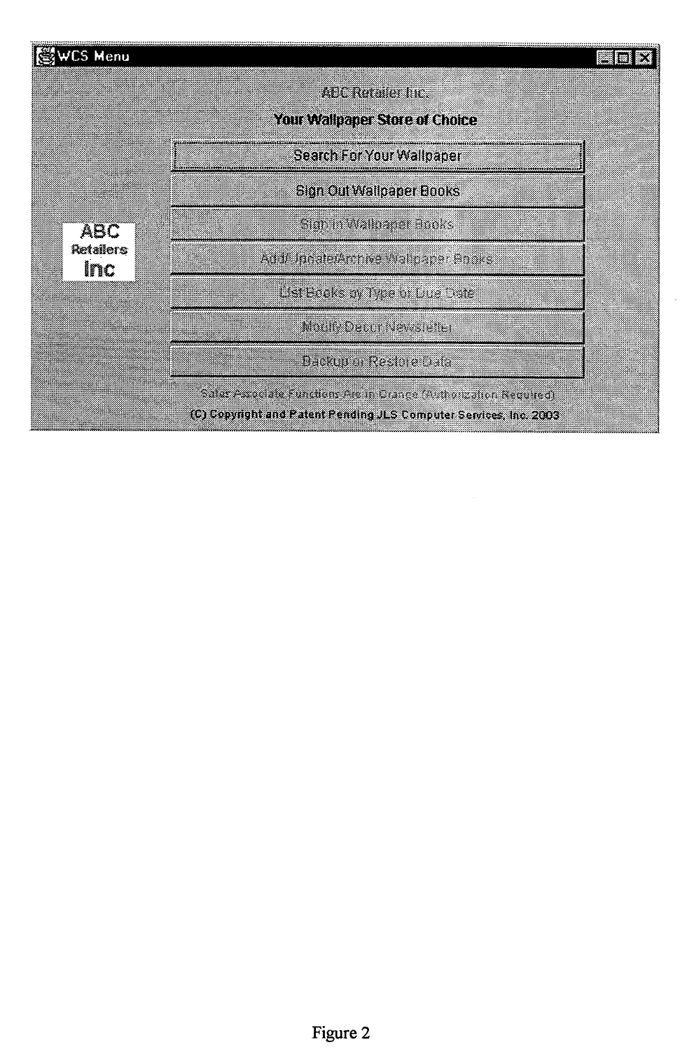

FIG. 2 is displayed when the Wallpaper Catalogue System is first initialized or when a user returns to it from another screen. It lists the system functions that can be accessed via this screen:
A search can be performed.
Books can be signed out.
When books are returned, sales personnel can sign them back into the system.
Sales personnel can add, update or archive wallpaper books.
Sales personnel can list books by type or date due.
The system can provide the ability to update and select from the following what can be printed on the search results and sign out lists:
   a list of additional products that the customer may want to purchase
   instructions on how to remove and/or install wallpaper
   a newsletter
   a coupon to be used on store products
The system can provide the ability to easily backup and restore the database.
Functions accessed by sales associates, managers and system operators can require specific login authorization ids and password entry.

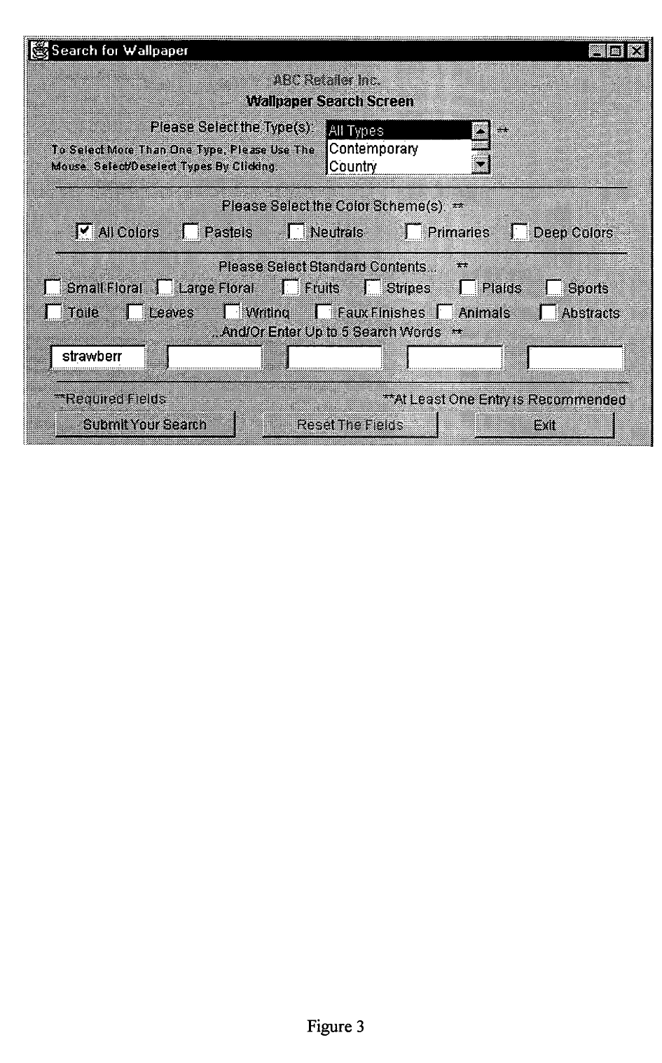

FIG. 3 can be displayed when accessed from FIG. 2 and allows customers or sales personnel to search for wallpaper motifs and/or colors. General color schemes can be supplanted by more specific ones. Wildcard characters are acceptable in the keyword search fields. For example, if the user wishes to find wallpaper patterns that have a “berry” motif, the system can accept the keyword “% berr” and can find all patterns that are defined by the keywords “strawberries”, “strawberry”, “blueberries”, “berries”, etc.

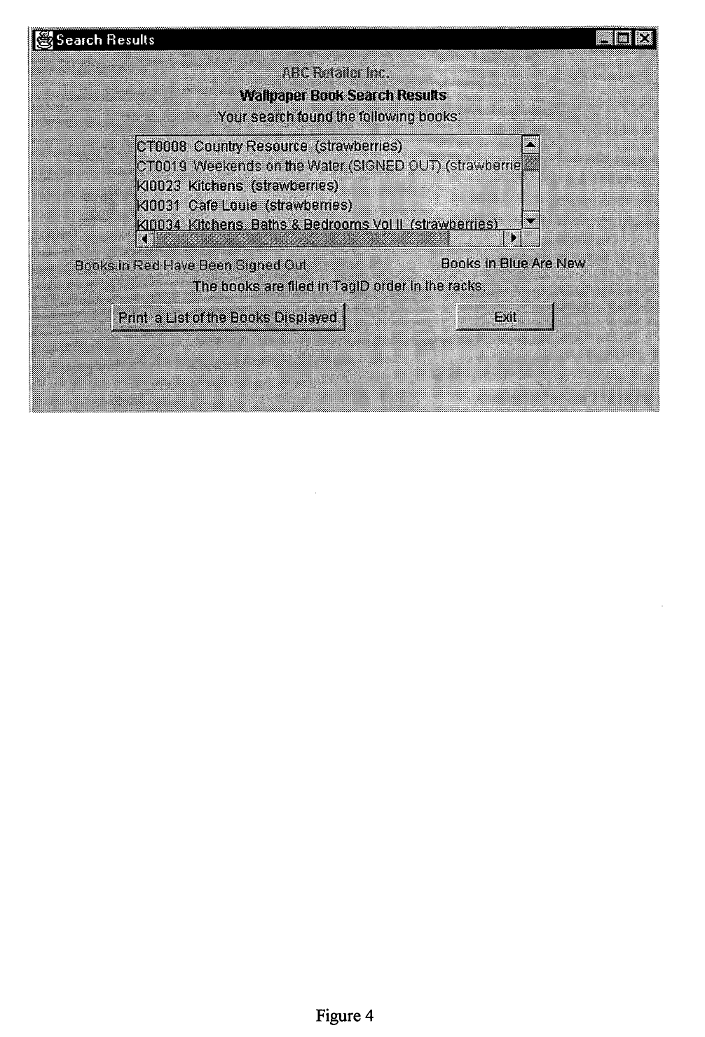

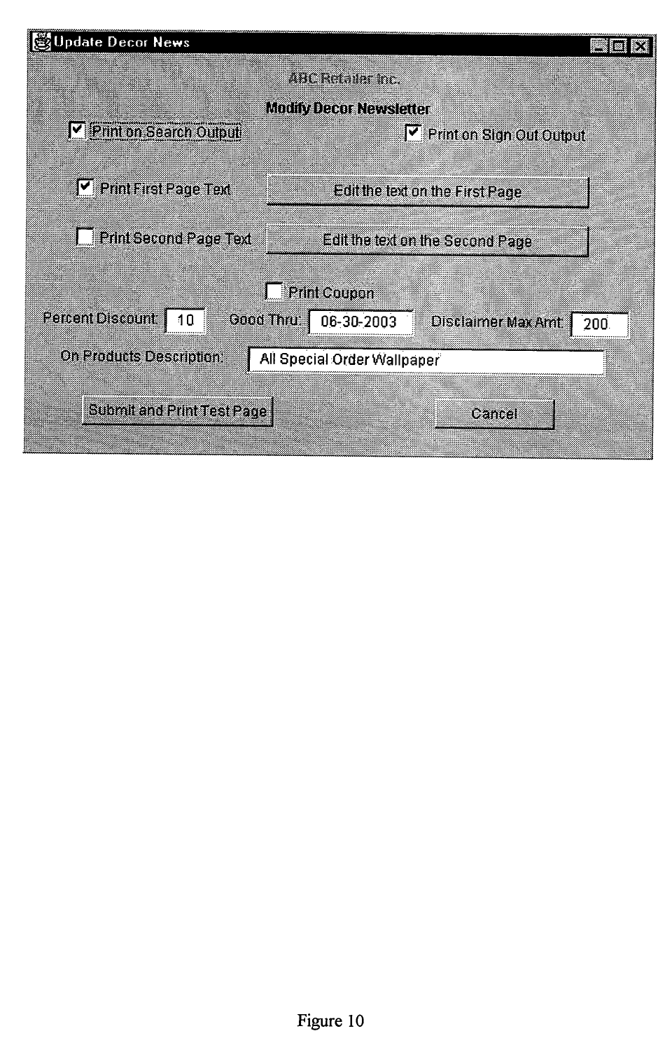

FIG. 4 can be displayed when a customer or sales person requests a search from FIG. 3. This window lists the results of the wallpaper search in tag identification order. The wallpaper books can have a unique tag id applied to the book spine and can be filed in that order facilitating locating them. Each item in the list can be accessed to display the actual pattern. The list of books selected can be printed. Additional products that a customer may need and consider purchasing can be printed on the bottom of this list. See the detailed description of the system under FIG. 10.

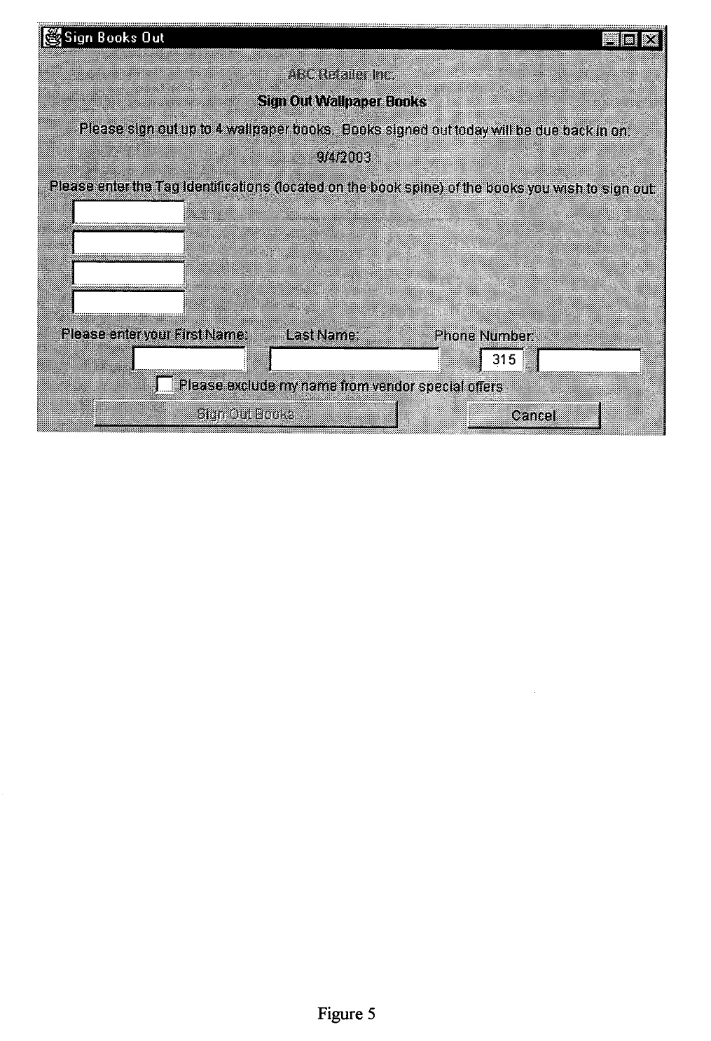

FIG. 5 can be displayed when accessed from FIG. 2 and allows customers or sales personnel to sign/check out wallpaper books. When the tag id of the book is entered, the system can automatically display the book title. If the book is already signed out, the user can be added to a wait-list. The customer has the option of being excluded from any solicitation lists that may be extracted from the system. The action of signing out the books can generate a sign-out list for validation purposes at a store checkout.

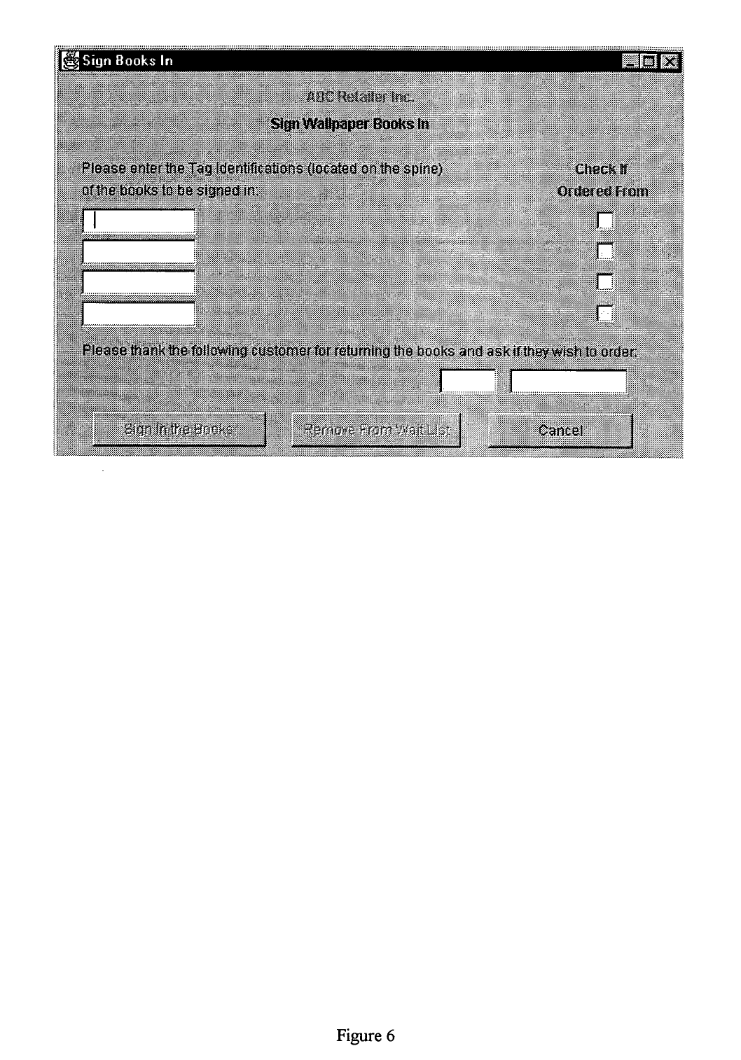

FIG. 6 can be displayed when accessed from FIG. 2 and allows sales personnel to sign/check in wallpaper books. Ordering information can be obtained from this screen. The system will not exclude interfacing with the retailers current ordering system from this window if such an interface is provided.

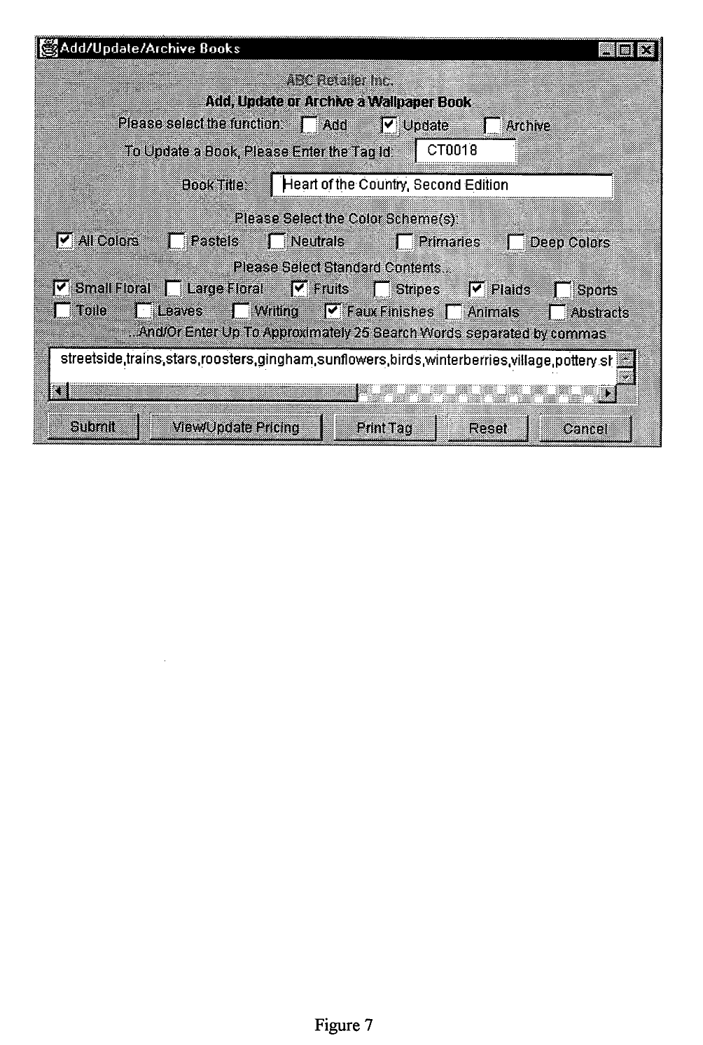

FIG. 7 can be displayed when accessed from FIG. 2 and allows sales personnel to add or activate, update or archive/deactivate wallpaper books. General color schemes can be supplanted by more specific ones. When a book is added or updated, the system can automatically decipher and add keywords from the title in addition to those supplied by the user. The system can also permit tag id label reprinting. In the case of a book addition, the system can automatically generate a new tag identification based on the current database books.

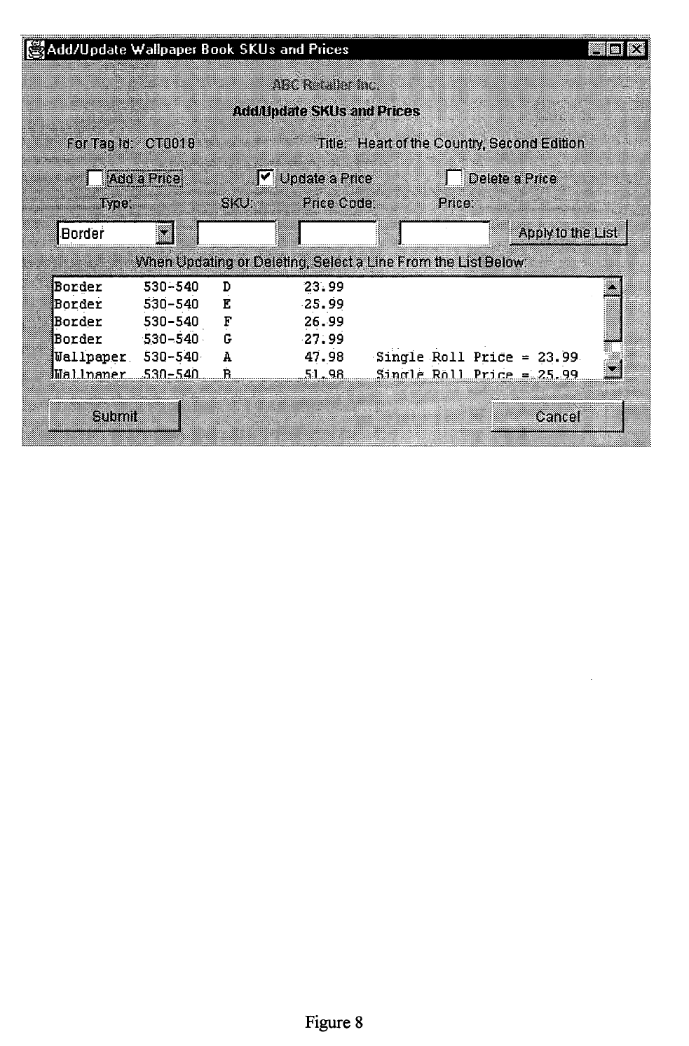

FIG. 8 can be displayed when accessed from FIG. 7 and allows sales personnel to add or update wallpaper book pricing information. This window can automatically be displayed when a book is added. Individual pattern identifications and pricing information can also be retained in the system.

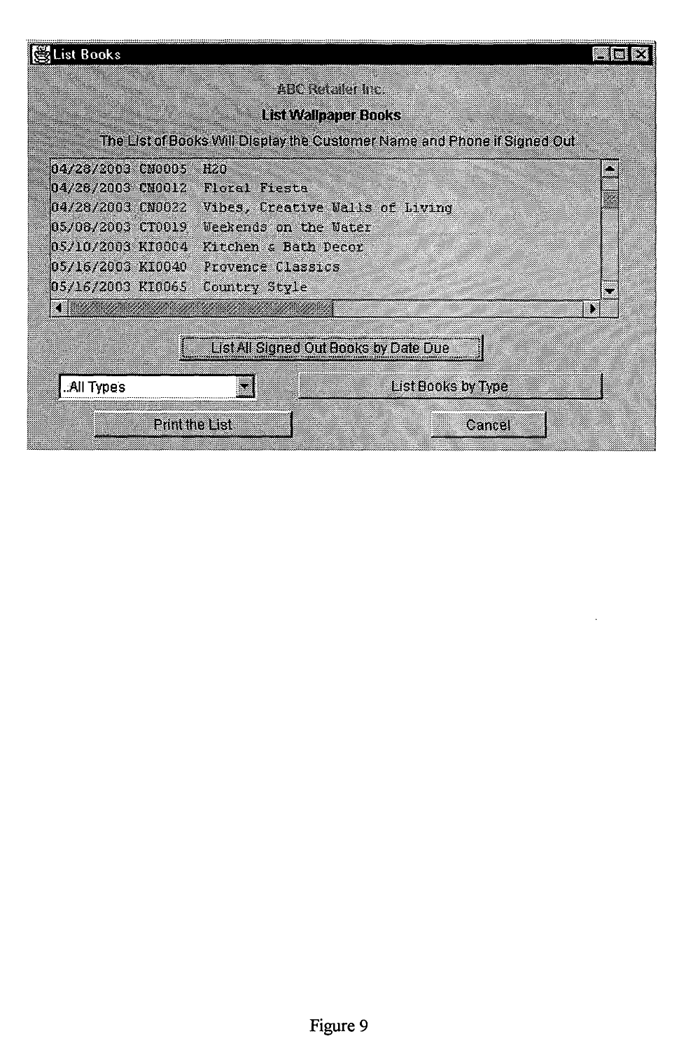

FIG. 9 can be displayed when accessed from FIG. 2 and allows sales personnel to list book inventories and/or list the wallpaper books that are currently in signed out status.

FIG. 10 can be displayed when accessed from FIG. 2 and allows management or sales personnel to revise the list of additional products, wallpaper removal/install instructions, coupon criteria or other marketing information that can print on the search and sign out verification printouts.

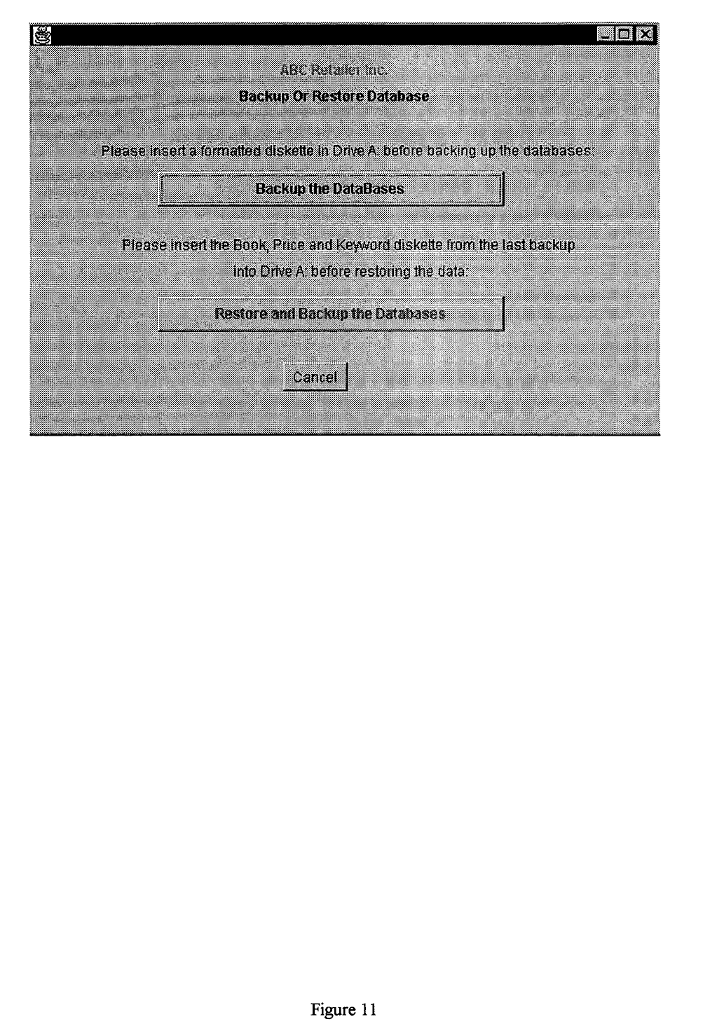

FIG. 11 can be displayed when accessed from FIG. 2 and allows systems operations and database administration personnel to easily backup and/or restore the system databases.

While various embodiments of the present invention have been described above, it should be understood that they have been presented by way of example only, and are not intended to be limiting. Thus, the breath and scope of the present invention should not be limited by any of the above described exemplary embodiments, but should be defined only in accordance with the following claims and their equivalents.

1. In a system including a computer and a printer, a computerized method for:
(a) searching for wallpaper patterns in a retailer's wallpaper book inventory by color and/or motif; and
(b) signing/checking out wallpaper books; and
(c) signing/checking in wallpaper books; and
(d) adding/defining, activating, updating, deactivating and archiving wallpaper books; and
(e) adding pricing information for wallpaper patterns either generically or individually; and
(f) listing wallpaper book inventory; and
(g) providing marketing information on customer printouts; and
(h) backing up and restoring wallpaper book databases.

2. The computerized method of claim 1, wherein the subject wallpaper book inventory is supplanted by millwright book inventory.

3. A program storage medium readable by a computer, tangibly embodying a program of instruction executable by the computer to perform the method steps comprising:
(a) searching for wallpaper patterns in a retailer's wallpaper book inventory by color and/or motif; and
(b) signing/checking out wallpaper books; and
(c) signing/checking in wallpaper books; and
(d) adding, activating, updating, deactivating and archiving wallpaper books; and
(e) adding pricing information for wallpaper patterns either generically or individually; and
(f) listing wallpaper book inventory; and
(g) providing marketing information on customer printouts; and
(h) backing up and restoring wallpaper book databases.

4. The computer readable medium of claim 3, wherein the method steps apply to millwright book inventory.
